(19) United States
(12) Patent Application Publication
(10) Pub. No.: US 2021/0149928 A1
(43) Pub. Date: May 20, 2021

(54) DATA PROCESSING SYSTEM FOR GENERATING WEATHER REPORTS AND RELATED METHODS

(71) Applicant: WEATHER STRIKE, LLC, Houston, TX (US)

(72) Inventor: Robert L. Wright, Houston, TX (US)

(21) Appl. No.: 16/952,200

(22) Filed: Nov. 19, 2020

Related U.S. Application Data
(60) Provisional application No. 62/937,404, filed on Nov. 19, 2019.

(51) Int. Cl. G06F 16/29; G06F 16/9535; G01W 1/00; H04W 4/12; H04W 4/021

(52) U.S. Cl. CPC G06F 16/29; G06F 16/9535; H04W 4/021; H04W 4/12; G01W 1/00

(57) ABSTRACT

A data processing system is for producing a weather report. The data processing system may include external weather event databases, each external weather event database having a different weather event data set. The data processing system may include a local database, and a server in communication with the local database and the external weather event databases. The server may be configured to import the different weather event data sets from the external weather event databases, perform a filtering process on the different weather event data sets from the external weather event databases, receive a geolocation from a user, and generate the weather report based upon the filtered different weather event data sets from the external weather event databases.

### RELATED METHODS

### Related Application

This application is based upon prior filed copending Application No. 62/937,404 filed Nov. 19, 2019, the entire subject matter of which is incorporated herein by reference in its entirety.

### TECHNICAL FIELD

The present disclosure relates to the field of data processing, and, more particularly, to a system for processing weather data and related methods.

### BACKGROUND

Weather tracking and forecasting is important for protecting life and property from severe weather systems. One important component in weather tracking and forecasting is weather radar. In the United States, the National Weather Services (NWS), Federal Aviation Administration (FAA), and the U.S. Air Force operate a network of ground-based Doppler weather radars called Next-Generation Radar (NEXRAD). The NEXRAD system utilizes radar scan data to detect precipitation in the atmosphere as well as its movement. Data from the various NEXRAD stations may be combined to display regions of precipitation moving across a map.

With the information provided by radar or other weather imaging tools, forecasters attempt to predict when and where sever weather will occur. Numerical weather prediction (NWP) uses mathematical models of the atmosphere and oceans to predict the weather based on the measured weather conditions. While NWP modeling can be helpful, such modeling generally requires a large amount of computing power to process the voluminous data sets and complex equations required for such modeling. Moreover, NWP modeling may not provide the accuracy or granularity required for certain applications.

For example, in the insurance industry application, there is a need to determine weather events at a single residential or commercial address. This type of granularity may make this determination difficult. Indeed, in most cases, the answer for whether a specific weather event (e.g. a hail event) occurred at the address is merely a probability rather than an answer.

### SUMMARY

Generally, a data processing system is for producing a weather report. The data processing system may include a plurality of external weather event databases, each external weather event database comprising a different weather event data set. The data processing system may include a local database, and a server in communication with the local database and the plurality of external weather event databases. The server may be configured to import the different weather event data sets from the plurality of external weather event databases, perform a filtering process on the different weather event data sets from the plurality of external weather event databases, receive a geolocation from a user, and generate the weather report based upon the filtered different weather event data sets from the plurality of external weather event databases.

Another aspect is directed to a method for data processing for producing a weather report. The method includes operating a server in communication with a local database and a plurality of external weather event databases. Each external weather event database may include a different weather event data set. The method may include operating the server to import the different weather event data sets from the plurality of external weather event databases, perform a filtering process on the different weather event data sets from the plurality of external weather event databases, receive a geolocation from a user, and generate the weather report based upon the filtered different weather event data sets from the plurality of external weather event databases.

### BRIEF DESCRIPTION OF THE DRAWINGS

FIG. 1 is a schematic diagram of an example embodiment of a data processing system, according to the present disclosure.

FIGS. 2A and 2B depict a flowchart illustrating operation of the data processing system of FIG. 1.

FIGS. 3A-3G depict an example embodiment of a weather report from the data processing system of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

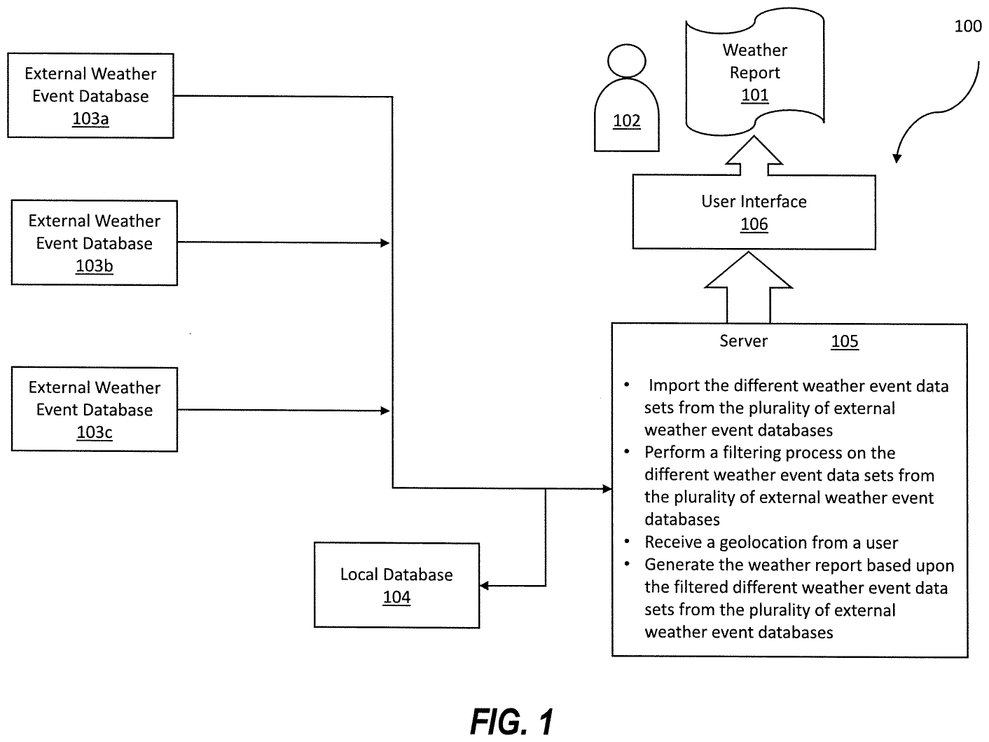

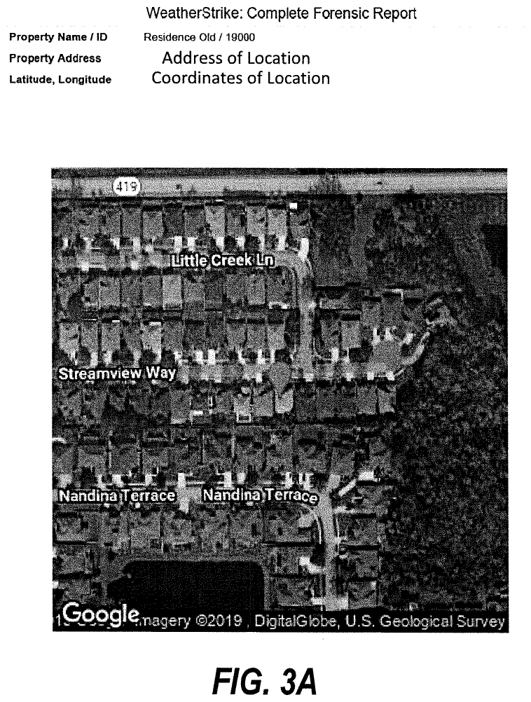

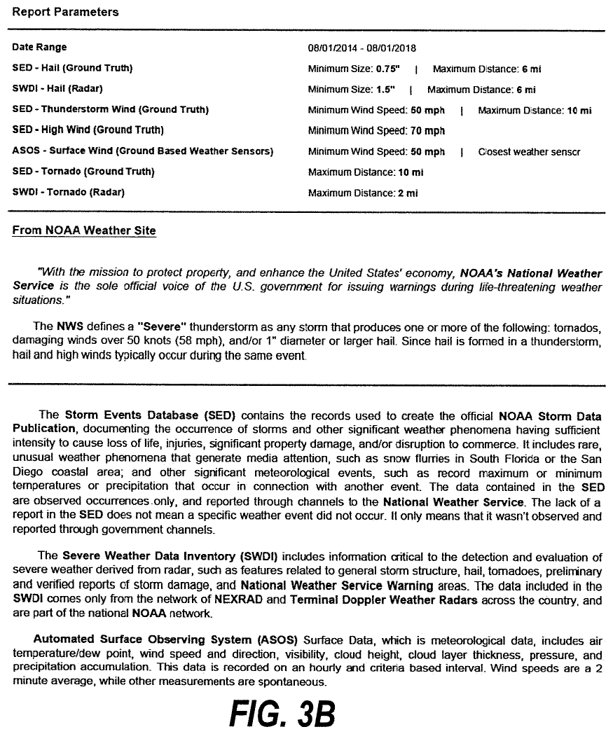

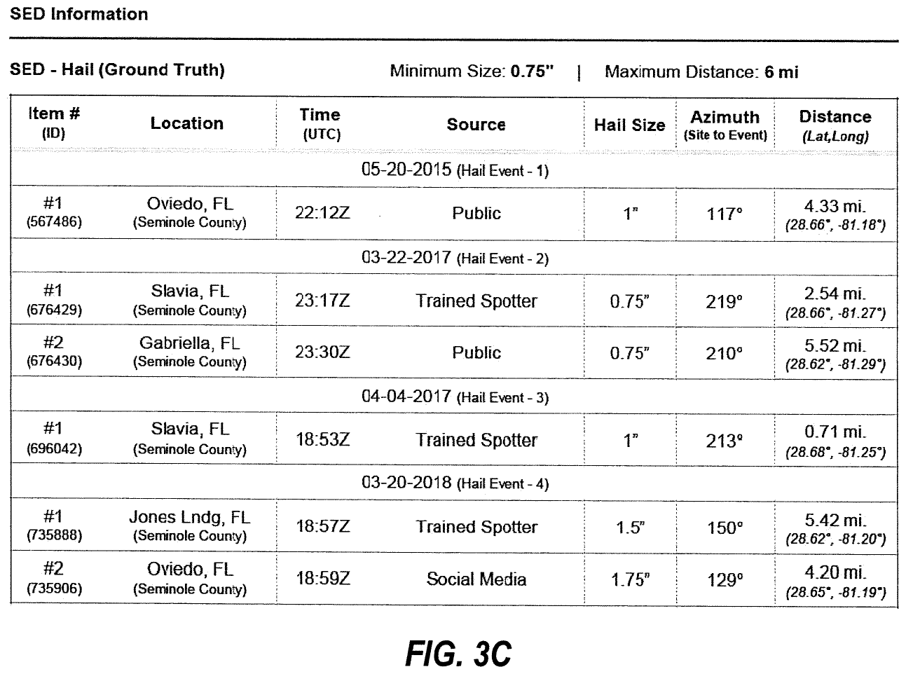

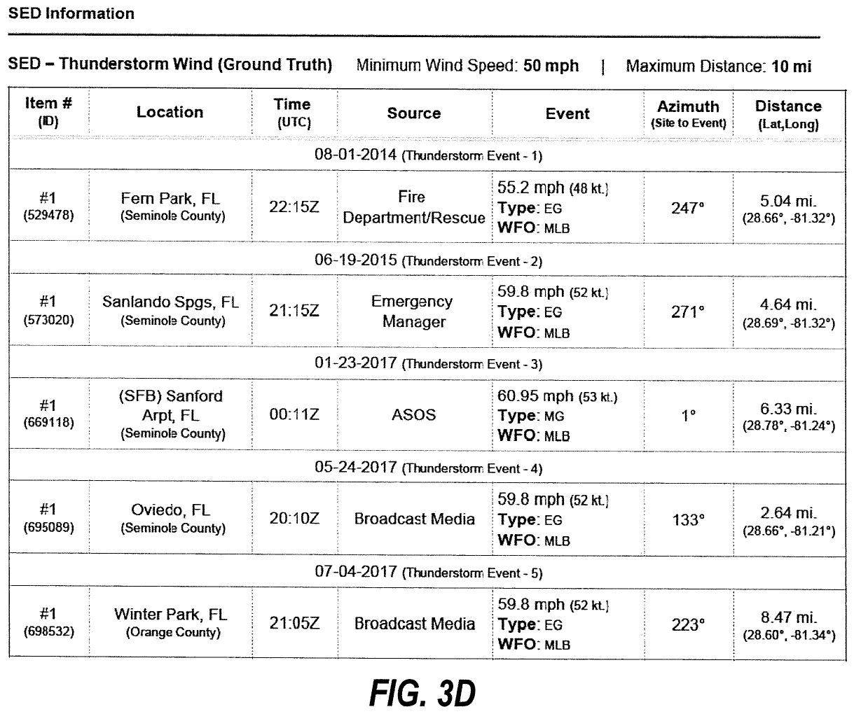

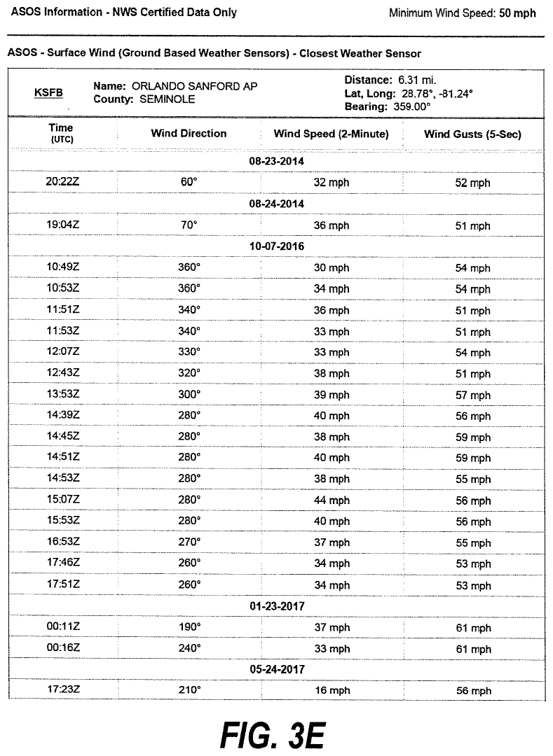

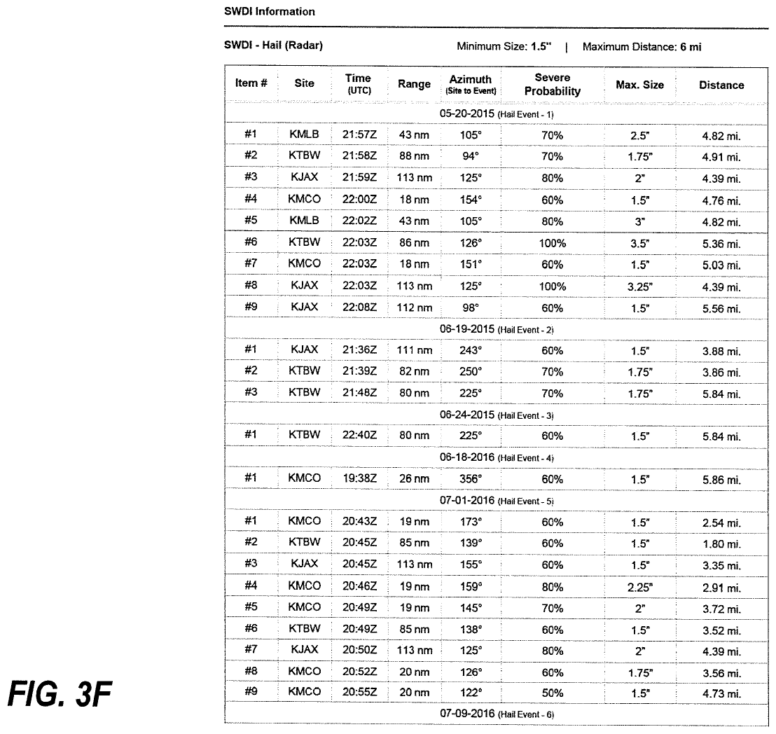

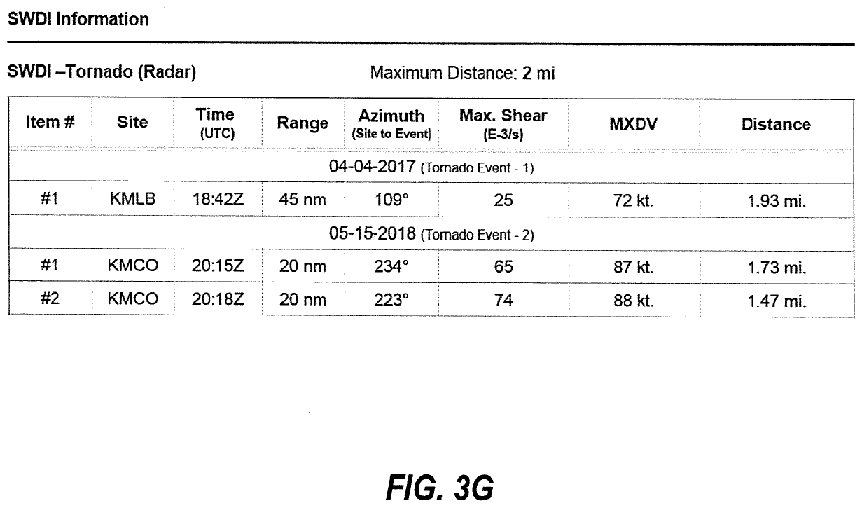

Referring initially to FIG. 1, a data processing system 100 according to the present disclosure is now described. The data processing system 100 is for producing a weather report 101 (See, e.g., FIGS. 3A-3G) for a user 102.

The data processing system 100 illustratively includes a plurality of external weather event databases 103a -103c. Each external weather event database 103a -103c comprises a different weather event data set (e.g. varying ground sources, methodology types). For example, the plurality of external weather event databases 103a -103c may comprise a NWS database, a Storm Prediction Center (SPC) database, a Storm Events Database (SED), a National Climatic Data Center (NCDC) database, a National Oceanic and Atmospheric Administration (NOAA) database, a Severe Weather Data Inventory (SWDI) database, an Automated Surface Observing System (ASOS) database, and an NEXRAD database. This listing is not exclusive, and other databases may be additionally or alternatively included.

The data processing system 100 illustratively includes a local database 104, and a server 105 in communication with the local database and the plurality of external weather event databases 103a -103c. In some embodiments, the local database 104 and the server 105 may be integrated. For example, the local database 104 and the server 105 may be provided via a cloud computing service, such as the Google Cloud Platform or Amazon Web Services, or by a single or set of standalone computing devices.

The server 105 is configured to import the different weather event data sets from the plurality of external weather event databases 103a -103c. The server 105 is configured to perform a filtering process on the different weather event data sets from the plurality of external weather event databases 103a -103c. The server 105 is configured to receive a geolocation and a date value from the user 102. For example, the geolocation may comprise a physical street address, a latitude and longitude set of coordinates, or a geographic area, such a county or municipality.

In particular, the different weather event data sets may be filtered based upon a range about the geolocation value. For example, only data from within a 1-25 mile radius of the geolocation value may be retained. Also, the different weather event data sets may be filtered based upon a range about the date value. For example, only data from within a 15-120 minute time range of the date value may be retained.

In some embodiments, the different weather event data sets may be filtered based upon a type of associated weather event. For example, in the SED, the server 105 may retain only hail, wind, high wind, and tornado data. Moreover, the different weather event data sets may be filtered based upon a thresholding process. For example, the wind speed minimum may comprise 50 mph for retention, and the hail size minimum may comprise 0.75-5.0 inches for retention. Also, in some embodiments, the server 105 may retain only data with a minimum confidence score, or retain only data that is eyewitness confirmed. Also, these filtering criteria can be customized for each of the plurality of external weather event databases 103a -103c to attenuate or amplify based upon trustworthiness of the external weather event database.

The server 105 is configured to generate the weather report 101 based upon the filtered different weather event data sets from the plurality of external weather event databases 103a -103c. The weather report 101 may be rendered within the user interface 106 or within a downloadable file, such as portable document format (PDF) file.

To reduce bandwidth issues, in some embodiments, the server 105 is configured to limit the data retrieval to only the filtered different weather event data sets. In other embodiments, where low latency is desired, the server 105 is configured to batch download large portions or the entirety of the plurality of external weather event databases 103a -103c.

In the illustrated embodiment, the server 105 is configured to generate a user interface 106 for input/output with the user 102. For example, the user interface 106 may comprise a web interface rendered within a web browser application (mobile or desktop). The user interface 106 may also comprise an application programming interface for permitting native operating system applications to interact with the server 105.

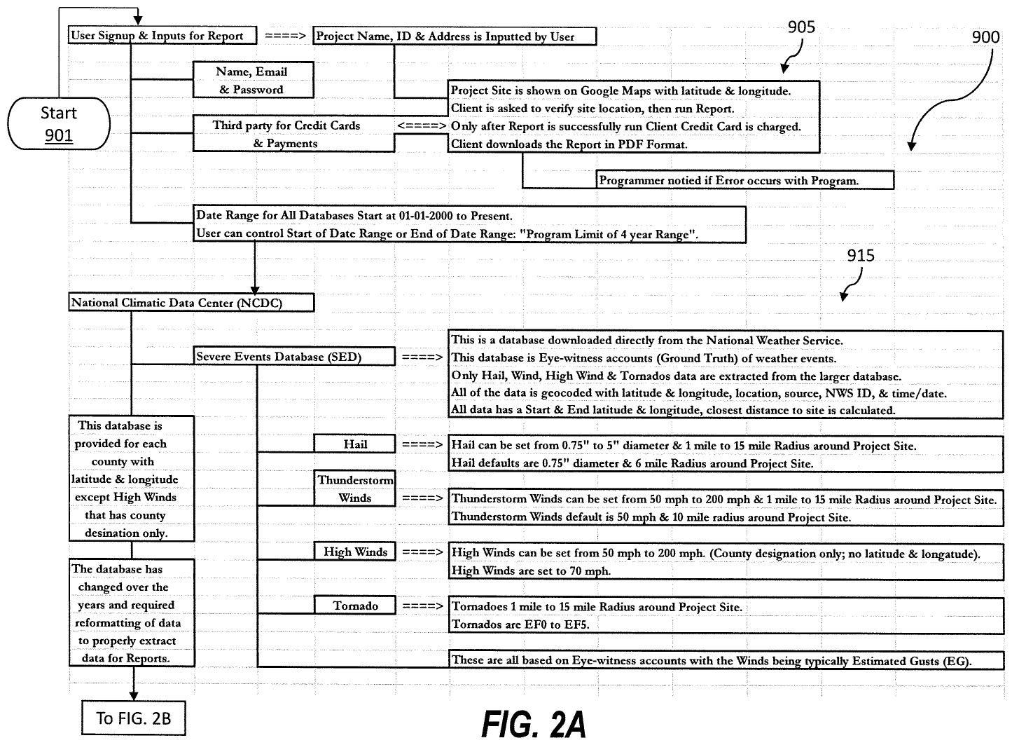

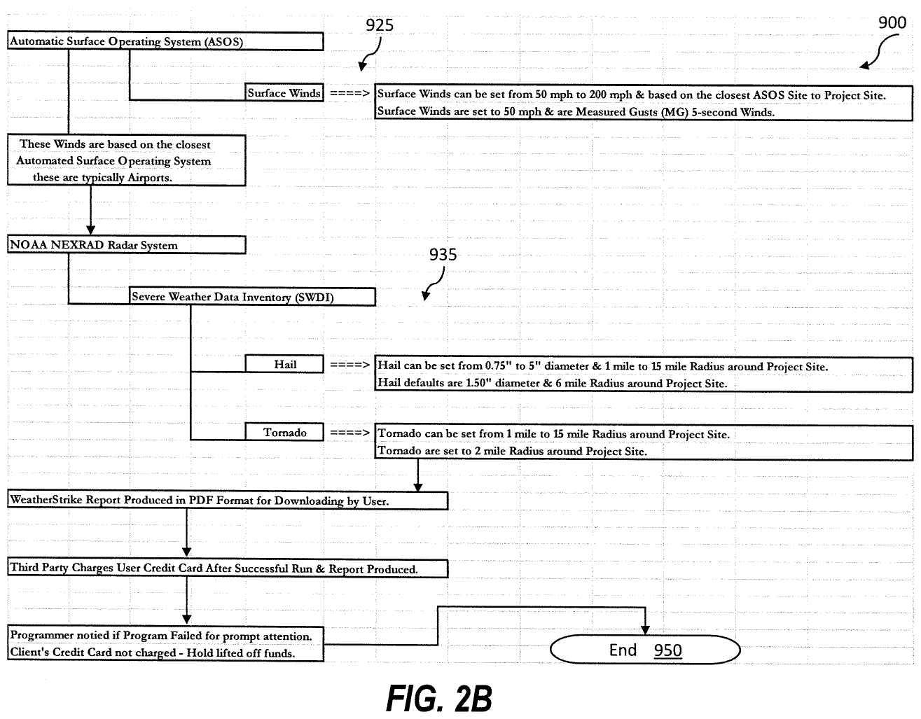

Referring now additionally to FIGS. 2A-2B, a flowchart 900 for operation of the exemplary embodiment of the data processing system 100 is shown. Beginning at Block 901, the method of operating begins. At Block 905, the method includes the preliminary interactions with the user 102 via the user interface 106. In particular, the geolocation and associated date value are received from the user 102. The user interface 106 is configured to render a map view of the geolocation for the user 102. In some embodiments, the user 102 may provide a range for the date value. Additionally, the user interface 106 also receives payment information from the user 102.

At Block 915, the data from the NWS and SED databases are downloaded by the server 105. At Block 925, the method includes downloading of data from the ASOS, NOAA, NEXRAD, and SWDI databases. The method includes the filtering process for this data, and generation of the weather report 101 at block 935. The method ends at Block 950.

Referring now additionally to FIGS. 3A-3G, an exemplary embodiment of the weather report 101 is shown. As shown in FIG. 3A, the map preview of the geolocation data is provided within the weather report 101. In FIG. 3B, the filtering parameters are provided. In FIGS. 3C-3G, the filtered data is presented to the user.

Another aspect is directed to a method for data processing for producing a weather report 101. The method includes operating a server 105 in communication with a local database 104 and a plurality of external weather event databases 103a -103c. Each external weather event database 103a -103c includes a different weather event data set. The method includes operating the server 105 to import the different weather event data sets from the plurality of external weather event databases 103a -103c, perform a filtering process on the different weather event data sets from the plurality of external weather event databases, receive a geolocation from a user 102, and generate the weather report 101 based upon the filtered different weather event data sets from the plurality of external weather event databases.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

What which is claimed is:

1. A data processing system for producing a weather report, the data processing system comprising:
a plurality of external weather event databases, each external weather event database comprising a different weather event data set;
a local database; and
a server in communication with said local database and said plurality of external weather event databases and configured to
import the different weather event data sets from said plurality of external weather event databases,
perform a filtering process on the different weather event data sets from said plurality of external weather event databases,
receive a geolocation from a user, and
generate the weather report based upon the filtered different weather event data sets from said plurality of external weather event databases.
